(19) United States
(12) Patent Application Publication
(10) Pub. No.: US 2025/0284616 A1
(43) Pub. Date: Sep. 11, 2025

(54) REWIND DEBUGGER

(71) Applicant: Xano, Inc., Woodland Hills, CA (US)

(72) Inventors: Sean Montgomery, Woodland Hills, CA (US); Weikang Zhao, Laverton (AU)

(21) Appl. No.: 19/069,466

(22) Filed: Mar. 4, 2025

Related U.S. Application Data
(60) Provisional application No. 63/561,540, filed on Mar. 5, 2024.

(51) Int. Cl. G06F 11/362

(52) U.S. Cl. CPC G06F 11/362

(57) ABSTRACT

Methods, systems, and computer programs are presented for capturing a program during execution to enable rewind debugging and debugging by other users. The technology includes an Application Programming Interface (API) Builder System (ABS) that provides features to enable users to execute API functions without the requirement to write code. The ABS provides a debugger that executes the complete set of instructions to completion while recording the values of all variable states at each instruction, enabling real-time feedback without any delay or need for warming up. Playback is made possible by capturing all variable states, which can be archived and restored at a later time for viewing the debugging session again. The ABS debugger facilitates the replay of program execution with versatile debugging commands to navigate the instructions executed.

### CROSS-REFERENCE TO RELATED APPLICATIONS

This application claims the benefit of U.S. Provisional Patent No. 63/561,540, filed Mar. 5, 2024, and entitled “Rewind Debugger.” This provisional application is herein incorporated by reference in its entirety.

### TECHNICAL FIELD

The subject matter disclosed herein generally relates to methods, systems, and machine-readable storage media for debugging computer programs.

### BACKGROUND

Automatic programming is a type of computer programming in which a mechanism generates a computer program to allow a human programmer to write code at a high abstraction level. For example, systems exist that automate the creation of source code construction for all or part of a software application based on inputs received through a user interface or input file, from which syntactically correct high-level source code (for example, C++, C#, Java, Python, Ruby, Perl, etc.) is automatically created. The created source code can be compiled or interpreted by the appropriate computerized system and subsequently executed.

However, having to program code is a significant barrier for individuals who are not programmers but want to access computer systems, such as servers that provide an Application Programming Interface (API) for accessing the data and services provided by the server.

When programmers execute code, they may run into problems with the program, and debuggers are used to troubleshoot problems with the program. When utilizing traditional debuggers, the user is required to proceed through the code step by step, pausing and resuming execution as necessary. This process often involves a repetitive cycle of pausing and resuming, which can result in the user failing to process certain steps. This can be particularly problematic in situations where an API request has time-sensitive dependencies, such as a token that is only valid for a limited period. In such cases, the use of a debugger may disrupt the flow of the code as time continues to progress while the user is paused at a particular step.

### BRIEF DESCRIPTION OF THE DRAWINGS

Various appended drawings illustrate examples of the present disclosure and cannot be considered limiting its scope.

FIGS. 1A-1B show a sample user interface (UI) for generating code according to some examples.

FIG. 2 is a user interface (UI) for executing computer instructions according to some examples.

FIG. 3 is a UI for debugging computer instructions according to some examples.

FIG. 4 illustrates navigation to computer instructions in the debug mode according to some examples.

FIG. 5 illustrates how to travel through steps in debugging mode according to some examples.

FIG. 6 illustrates the option to execute one pass of a for-loop according to some examples.

FIG. 7 illustrates debugging inside a function according to some examples.

FIG. 8 is a flowchart of a method for executing instructions with the active debugger, according to some examples.

FIG. 9 is a flowchart of a method for debugging previously executed instructions, according to some examples.

FIG. 10 is a simplified schematic diagram of a computer system for implementing the examples described herein.

FIG. 11 is a flowchart of a method for debugging a computer program, according to some examples.

FIG. 12 is a block diagram illustrating an example of a machine upon or by which one or more example processes described herein may be implemented or controlled.

### DETAILED DESCRIPTION

Example methods, systems, and computer programs are directed to capturing the state of a program while the program is executed to enable rewind debugging and debugging by other users. Examples merely typify possible variations. Unless explicitly stated otherwise, components and functions are optional and may be combined or subdivided, and operations may vary in sequence or be combined or subdivided. In the following description, numerous specific details are set forth to provide a thorough understanding of examples. However, it will be evident to one skilled in the art that the present subject matter may be practiced without these specific details.

Methods, systems, and computer programs are presented for capturing the state of a program at each step during the execution of the program to enable rewind debugging and debugging by other users. The technology includes an Application Programming Interface (API) Builder System (ABS) that provides features to enable users to execute API functions without the requirement to write code explicitly. The ABS includes a debugger that executes the complete set of instructions to completion while recording the values of all variable states at each instruction, enabling real-time feedback without any delay or need for warming up. Playback is made possible by capturing all variable states, which can be archived and restored at a later time for viewing the debugging session again. The ABS debugger facilitates the replay of program execution with versatile debugging commands to navigate the instructions executed.

An API is a computing interface that defines interactions between multiple software intermediaries. It defines the kinds of calls or requests that can be made, the calling sequence of a call stack, how to make them, the data formats that should be used, and the conventions to follow. An API works by sending requests for information from a web application or web server and receiving a response, wherein the requests comprise inputs based on the requirements and configurations of the API. Traditionally, configuring an API requires a programmer to write custom code to perform specific API commands, which can often be prohibitively expensive or time-consuming.

In one aspect, the ABS provides features to enable users to execute API functions without the requirement to write code. The ABS is a no-code backend that enables easy access to servers that implement APIs. A user may provide input to an interface element to display a menu element to define one or more functions associated with a function stack of an API, where the functions comprise commands. The ABS provides a representation of the functions in a function stack to access the API and perform data selection and manipulation.

In one aspect, the ABS provides a debugger, which, unlike traditional debuggers, executes the complete set of instructions to completion while recording the values of all variable states at each instruction. Thus, the ABS debugger does not have to implement the features of pause and resume because the code is executed in its entirety.

A function stack refers to a sequence or collection of functions that are executed in a specific order within a program. The function stack is a conceptual structure that represents the hierarchy and order of function calls during the execution of the program. Each function call is added to the stack, and as functions complete their execution, they are removed from the stack. This stack-like behavior allows for the management of function calls and returns, enabling the program to keep track of where it is in the execution process.

During the debugging process, the user is able to navigate forward and backward through program execution, as the location of the issue is identified in advance. The ABS debugger facilitates the replay of program execution, similar to a DVR system, allowing for both slow and fast replay. This feature is noteworthy and adds to the overall appeal of the debugger.

The ABS debugger enables playback by recording the state of all variables during program execution. These recordings may be saved and later retrieved to revisit during a debugging session. Furthermore, playback is not restricted to the same application, as the variable state can be remotely shared for educational or support purposes, allowing others to view the debugging session precisely as it occurred.

Some terms used in this description are provided below:

Debug mode is a state of a software application that allows for the examination and analysis of the program's execution, enabling the identification and resolution of errors or issues.

Debug data is information collected during the execution of a program, which includes the state of the program after each instruction is executed and is used for analysis and troubleshooting.

Executed instructions are commands or operations that have been processed by a computer's processor as part of a program's execution.

A function stack is a sequence or collection of functions that are executed in a specific order within a program, representing the hierarchy and order of function calls during execution.

A program state captures the current status of a program at a specific point in time, including the values of variables and the position within the function stack.

A User Interface (UI) is a visual display that allows users to interact with a computer program, providing options and information related to the program's operation and state.

A variable is a storage location identified by a memory address and a symbolic name, which contains data that can be modified during program execution.

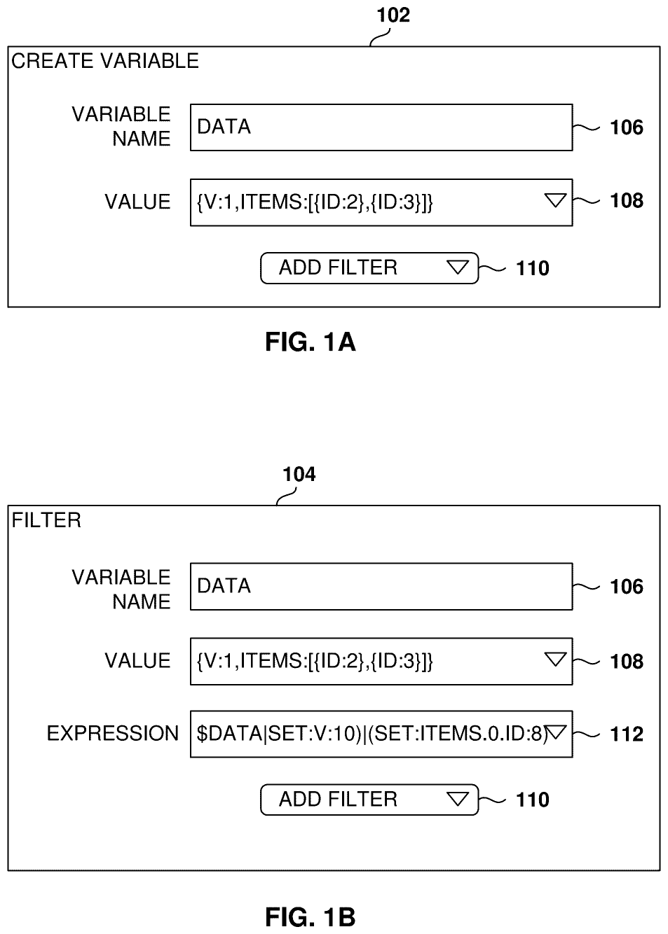

FIGS. 1A-1B show a sample user interface (UI) 102 for generating code, according to some examples. The UI 102 includes options for entering instructions to create ABS code. Instead of using a text editor to write code, a developer may use the UI 102 to enter information, such as variables, functions, transformations, etc., which correspondingly form at least one initial state. UI 102 extends to provide multiple initial states, where each initial state can represent a prescribed set of test conditions.

The ABS generates and causes the display of a UI that comprises a presentation of a plurality of interface elements, as depicted in FIGS. 1A-7. Each interface element among the set of interface elements may correspond with a code extension associated with a particular command or function. In some examples, the code extensions may include, but are not limited to, commands and functions such as conditionals, pre-conditionals, statements, and arrays. For example, in some examples, the plurality of interface elements may include: an “input” element that corresponds with a code extension to generate commands to define an input to an API automatically, a “function stack” element that corresponds with code extensions to automatically generate functions of a function stack based on user selections; and a “response” element, that corresponds with code extensions to automatically generate commands to define a response associated with an API.

Although the UI 102 is shown for a guided utility to create code, the ABS code may also be created with other tools, such as integrated development environments, text editors, instructions, and configurations generated by Artificial Intelligence (AI) (e.g., a Large Language Model), etc. Additionally, the ABS code may be used for many purposes, such as for input to compilers to generate machine code, input for interpreters, use as a browser add-in, integration with another type of code (e.g., JavaScript), mobile app development, manage Internet of Things devices, etc.

In the UI 102, the user has selected the option to create a variable. Field 106 is for entering the variable name, and field 108 is for entering a value for the variable. In the illustrated example, the user has created a variable named data, and the value for data, expressed in ABS format, is {v:1,items:{{id:2},{id:3}}}. Thus, the variable data includes a first field v, and an array of named items with two components, a first one with an id of 2 and a second one with an id of 3. Field 106 could be manually populated by a human programmer or could be generated by the AI model. Although examples are described with reference to users interfacing with the UI to generate a function stack, the same principles may be applied when the AI model generates instructions.

As used herein, a program instruction refers to a single command or operation of a programming language that is executed by a computer's processor. Each instruction is a part of a program's code and is written in a specific programming language syntax. These instructions are the building blocks of a program, directing the computer to perform specific tasks such as calculations, data manipulation, input/output operations, and control flow management. In some examples, a program instruction might involve arithmetic operations, logical comparisons, or function calls, each contributing to the overall functionality of the software application.

A menu 110 provides options to enter additional instructions. In this example, the user has selected to add a filter, and the result is shown in UI 104 of FIG. 1B. Field 112 has been added to enter an expression to access the variable data, and the sample expression is $data|(set:v:10)|(set:items.0.id:8). When the program is executed, the result of applying this expression to the variable data would be updating data to {v:10,items:{{id:8},{id:3}}}.

The ABS presents a menu element based on the selection of the interface element, wherein the menu element may comprise a display of one or more user-selectable options that correspond with the selected menu element. For example, in some examples, the user-selectable options may comprise a display of a plurality of API input types from which a user may select.

After the user completes entering instructions, the ABS configures an API (e.g., an API endpoint) based on the user input received via the menu element. As an illustrative example, the user input may comprise a selection of an API input type from among a set of API input types.

The ABS is configured to receive input that defines a parameter of a command associated with a function via a menu element presented within a GUI. For example, the parameter may include an input that defines a variable or identifies the source of a variable. Responsive to the input that defines the parameter, the ABS generates pseudo-code based on the command and presents the pseudo-code within the UI.

According to some examples, the ABS generates a function based on user input received through a menu element of the UI. For example, the user input may define a function by selecting command parameters from a menu element that comprises a display of user-selectable options, wherein the parameters may define attributes of an output of the command, such as a variable.

The ABS is also configured to present an interface element that represents the function at a position among a sequence of interface elements, where the position among the sequence of interface elements precedes a second interface element. For example, an interface element may correspond with a function that includes a command to define a variable.

According to some examples, a user may provide an input to the UI in order to display a menu element to define one or more inputs to the API. For example, the inputs may define parameters of an input, such as an input type, as well as an identifier to be associated with the input. Responsive to receiving the inputs to define the parameters of the input, the ABS may present one or more graphical icons that represent the defined inputs.

According to certain examples, the user may provide input in the UI to define a response which may be performed by the API. For example, the input may select one or more elements (e.g., variables), as well as instructions for presenting or displaying the elements. For example, a user may configure the API to present the selected elements in the body of an email.

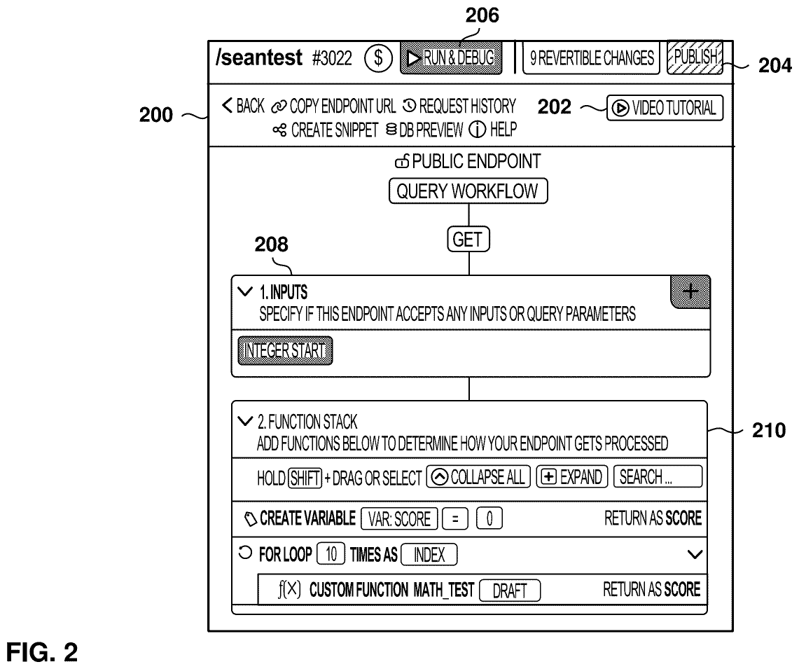

FIG. 2 is a user interface (UI 200) for executing computer instructions according to some examples. The UI 200 is structured to facilitate the creation and execution of API endpoints, allowing users to define inputs and a sequence of operations, known as a function stack, to process these inputs.

The UI 200 facilitates the creation and execution of API endpoints, allowing users to define inputs and a sequence of operations, known as a function stack, to process these inputs. The UI presents an API endpoint named seantest displayed at the top of the interface.

A navigation bar 202 includes various options such as “Back,” “Copy Endpoint URL,” “Request History,” “Create Snippet,” “DB Preview,” “Help,” and “Video Tutorial.” These options allow users to navigate through different functionalities of the ABS, providing access to historical data, code snippets, database previews, and instructional resources.

The “Run & Debug” button 206 enables users to execute the defined API endpoint and initiate the debugging process. This button triggers the execution of the function stack and provides real-time feedback on the operation of the API.

The “Publish” button 204 is available for users to finalize and deploy the API endpoint, making it accessible for external use. This action transitions the endpoint from a draft state to a live state, ready for integration with other systems.

The inputs section 208 is designed to specify any inputs or query parameters that the endpoint accepts. This section allows users to define the type and nature of the input data required for the execution of the API functions. In some examples, the input can be an integer, as shown in the figure, which is used to initialize variables or parameters within the function stack.

The function stack 210 shows the function stack of the endpoint. This function stack 210 is a sequence of operations that are executed in a specific order. The API endpoint includes the creation of a variable score and a for-loop to be executed ten times. Inside the for-loop, a custom function math_test is executed. The illustrated function stack includes a “Create Variable” operation, which initializes a variable named “score” with a value derived from the input.

The function stack includes a “For Loop” operation, which iterates a specified number of times, as indicated by the “times as index” parameter. This loop is used to perform repetitive operations, such as executing a custom function multiple times. In the illustrated example, the loop iterates ten times.

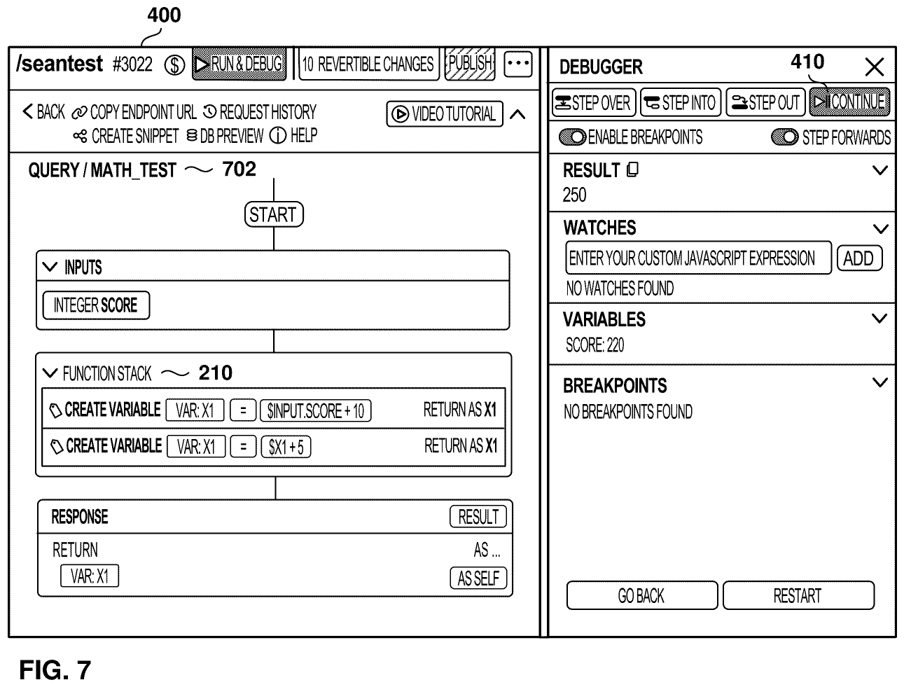

The “Custom Function math_test” is the final operation in the function stack 210. As seen in FIG. 7, the math_test function creates a variable x1 that is initialized with the input score plus 10. In a second instruction, the variable x1 is incremented by 5. Basically, the math_test function adds 15 to the input and returns the result. For example, if the user enters 0 as input, math_test will return 15.

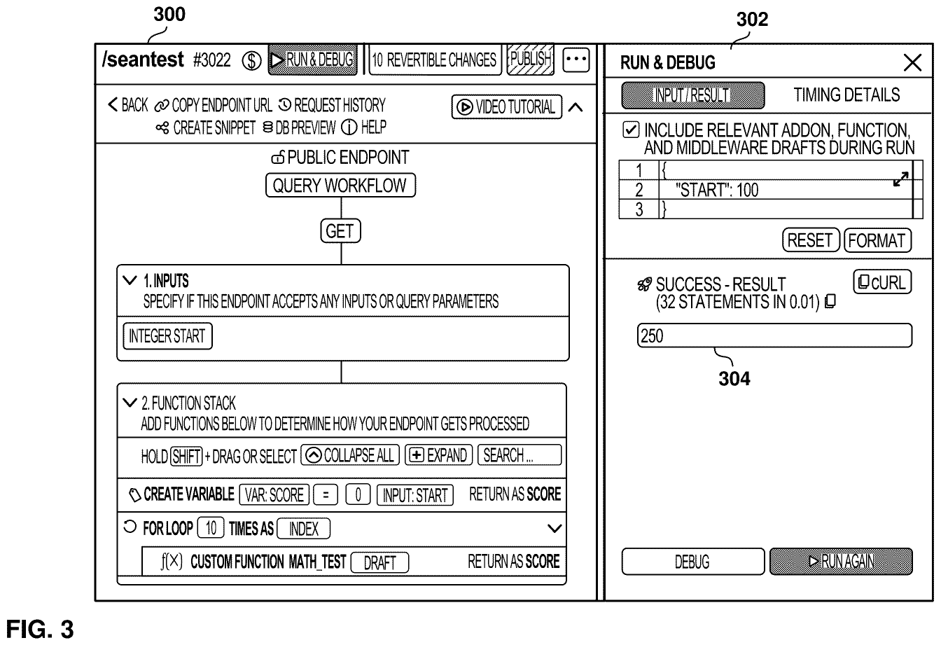

FIG. 3 is a UI 300 for debugging computer instructions and analyzing execution time and resource utilization measured during debugging, according to some examples. In the illustrated example, the user has entered 100 as the initial value for the score. After executing seantest, the for loop is executed ten times, so the value 15 is added ten times, and the final result is 250.

The left section of the UI 300 is dedicated to the configuration and execution of an API endpoint named seantest. The right section of the UI 300 includes a “Run & Debug” panel 302, which is used to execute the defined API endpoint and initiate the debugging process. The panel 302 includes tabs for “Input/Result” and “Timing details,” allowing users to switch between viewing the input and output of the execution and analyzing the timing details of each operation.

The panel 302 displays the input data in a structured format, showing the initial value for the start variable as 100. The panel 302 provides a “Success” message indicating the result of the execution, which in this case is 250, achieved after executing 32 statements in 0.01 seconds. The result is displayed in field 304 which allows users to view the output of the execution.

The interface also includes buttons for “Reset,” “Format,” “Debug,” and “Run again.” The “Reset” button allows users to clear the current input and output data, while the “Format” button provides options for formatting the displayed data. The “Debug” button initiates the debugging process, and the “Run again” button allows users to re-execute the API endpoint with the same or modified inputs.

Subsequent additional values can be used for score to ensure that the logic being debugged in seantest is exercised with a wide range of input values, e.g., the aforementioned multiple initial contexts formed by a human programmer or AI. Further, making timing details available enables the user to understand how much time each aspect of the logic takes to execute. Also, the timing details increase the efficiency of a human programmer, who is guided by these timing details to focus optimization efforts on instructions that consume an unexpected or unacceptable amount of time and resources.

FIG. 3 depicts items of interest to the user, such as variables, and the debugger empowers the user to hover a mouse cursor over any variable or item of interest in order to understand the current value of a variable or related execution time. The timing detail and run-again button work in corresponding ways that enable benchmarks to be formed. Benchmarks refer to the measurement of the performance of a system, and in order to acquire an objective measurement of performance, multiple executions of logic are carried out to ascertain metrics such as execution time, memory usage, and network utilization.

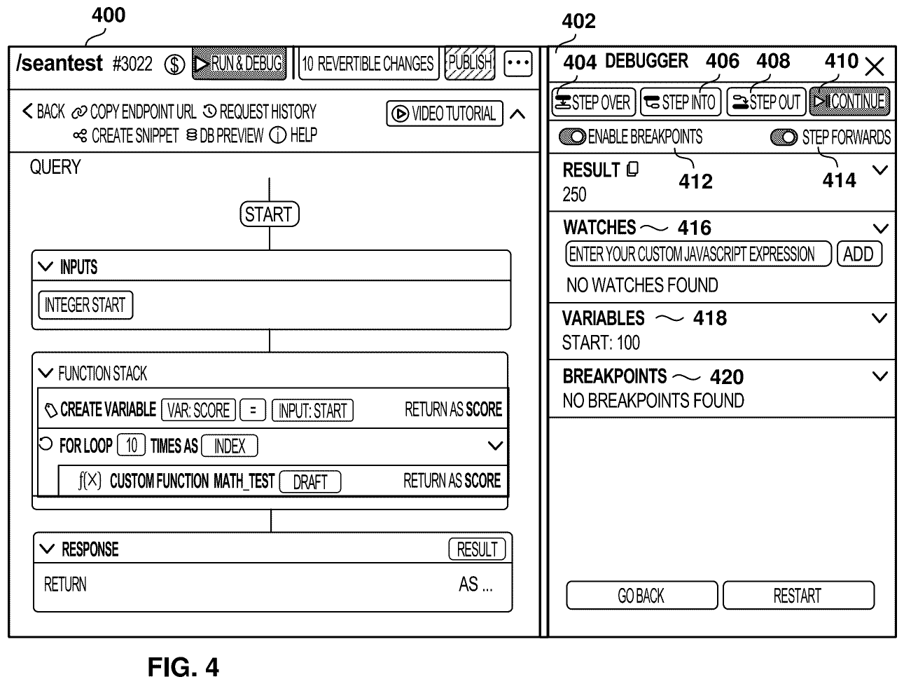

FIG. 4 is a UI 400 that illustrates navigation to computer instructions in the debug mode according to some examples. In the UI 400, the user has entered debug mode, such as by selecting the Debug button of FIG. 3, to analyze the execution of the instructions.

The debugger panel 402 includes the options to step over 404, step into 406, step out 408, and continue 410 till the end or until the next breakpoint. Further, the debugger includes option 412 for turning breakpoints on or off and option 414 to step forward or backward.

When the user selects step over 404, the ABS executes the current instruction completely, including any function calls, and does not enter inside the function being called. When the user selects step into 406, the ABS executes the current line until it encounters a function call, and then enters into the code inside the function and pauses at the first executable instruction inside the function.

With step out 408, the ABS executes the remaining code within the current function until it reaches the “return” statement or the end of the function and then jumps back to the line where the function was called.

The Watches section 416 provides a field for users to enter custom JavaScript expressions. This section is designed to allow users to monitor and evaluate specific variables or expressions during the debugging process. By entering a JavaScript expression, users can dynamically observe the values of variables or the results of expressions as the program executes. The Variables section 418 shows the variables being used during execution. Further, the Breakpoints section 420 presents the breakpoints set, if there are any.

There are two types of breakpoints. The first type of breakpoint is designed to pause execution at a specific point. The program runs at maximum speed until it reaches the designated point, where it halts. The second type of breakpoint, known as a conditional breakpoint, is particularly useful in loops. In the absence of a conditional breakpoint, loops with a large number of iterations can become problematic. However, with a conditional breakpoint, the program can be instructed to run at maximum speed until a specific iteration is reached, such as the 950,000^{th} iteration in a loop that runs a million times.

Most times, breakpoints are not used for debugging with ABS because the program executes till the end, and then the user can observe data for any state. With traditional programming, the breakpoint may be used to stop execution and analyze the data because if the program continues execution, the data will change and cannot be read. However, there may be some corner cases, like running a loop a million times, where conditional breakpoints may be useful so the user does not have to click on the loop instruction a million times.

In one example, the instructions are executed at high speed (e.g., without stopping) while simultaneously capturing memory snapshots at the completion of each instruction. The ABS enables instantaneous execution of instructions at any point during the process.

One advantage of the techniques presented is the ability to receive real-time feedback without any delay or need for warming up. Additionally, the capability to move backward is highly beneficial in situations where the user wants to understand how a particular outcome was reached. This feature eliminates the need to start execution over by simply moving the debugger backward, reducing the time it takes to debug instructions.

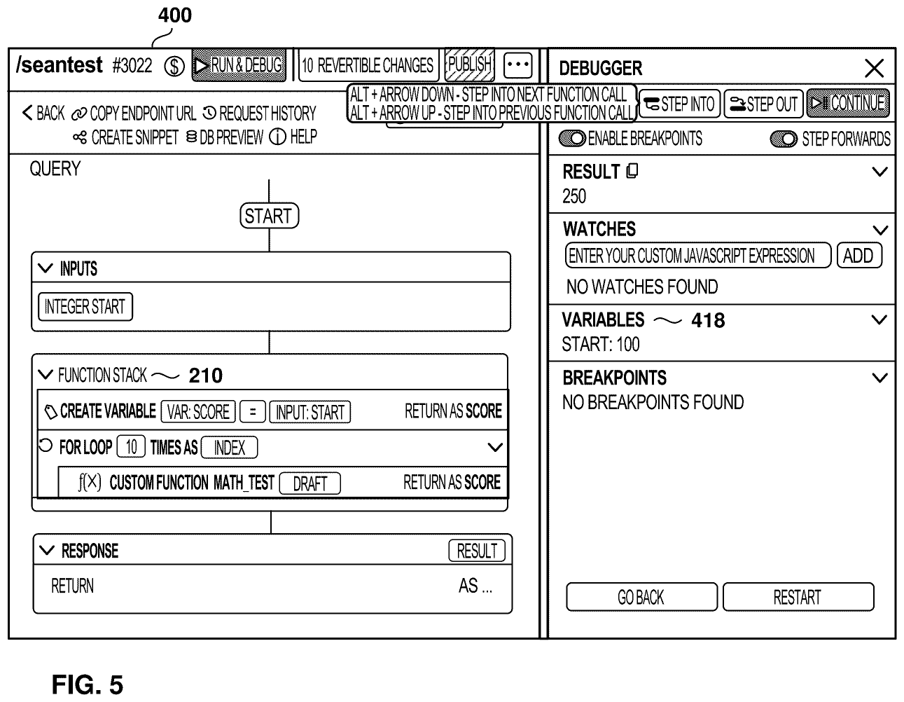

FIG. 5 illustrates how to travel through steps in debugging mode according to some examples. In the debugging mode, the user may click on any of the instructions in the function stack 210, and the debugger will automatically move the state to that instruction (e.g., right after the instruction is executed or before the instruction is executed, depending on the implementation). In this example, the variables section 418 displays the three variables: start, score, and index.

Due to the implementation of the ABS debugger, it is possible to debug a process in real time, even if it takes an hour to run. This is because all the necessary information is readily available. In contrast, the conventional approach requires pausing and resuming the process. The advantage of the ABS approach is that it allows for stepping backward and solving timing problems with the execution of code. That is, if the user has to set breakpoints to observe values, time-sensitive operations may fail. However, since the ABS debugger runs all the instructions to completion, no timing problems are introduced when using the debugger.

The ABS captures snapshots of the program state at each instruction, enabling a user to navigate to any point in the execution process without delay. In contrast, traditional debuggers require the program to process instructions sequentially until reaching the desired point, which can be time-consuming. This capability translates into significant UI advantages, as it facilitates the creation of workflows that allow for instantaneous navigation. Users can swiftly move to any execution point within the program, bypassing the slower, step-by-step progression typical of traditional debuggers.

In an example where the user is debugging a long function stack (e.g., 100 instructions), the user may click on instruction 2, then instruction 37, followed by instruction 2 again, then back to instruction 37, and the state is displayed instantly each time. That is, with a single click, the user may navigate to the first instruction, the last instruction, or anything in between.

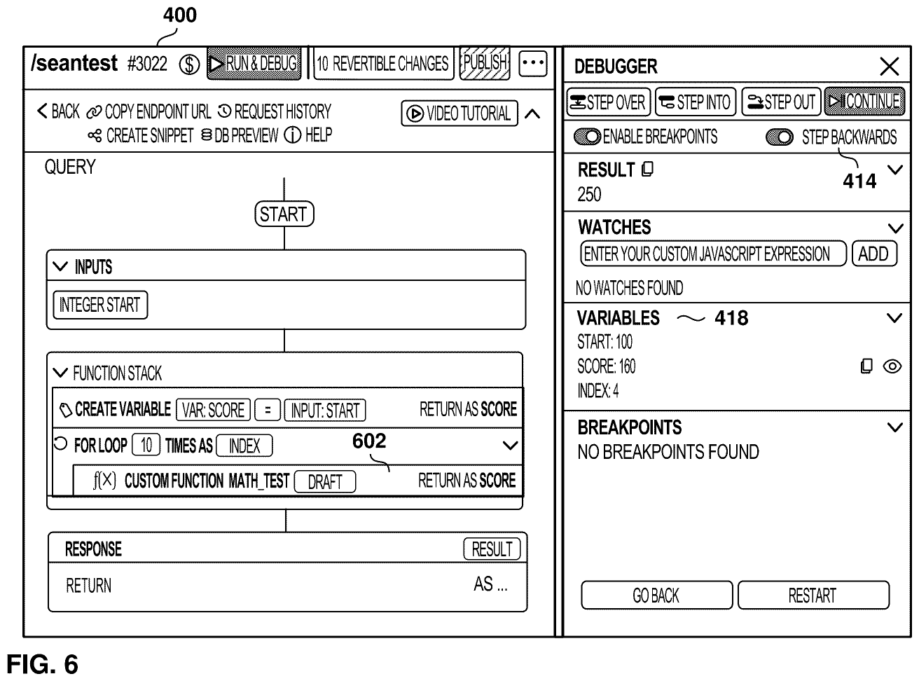

FIG. 6 illustrates the option to execute one pass of a for-loop according to some examples. Clicking on the for loop 602 will cause the debugger to move the state to the end of the first iteration. The user can then click on the for-loop 602 again, and each click will move the for-loop one iteration. This makes it very easy for the user to traverse through all the iterations of a for loop quickly. The ABS also provides an option to go back one iteration of the for loop (e.g., pressing the Shift key on the keyboard while clicking on the for-loop instruction).

In this example, the single instruction of the for loop 602 is a call to the function math_test, which adds 15 to the score. Thus, if the score begins with 100, after the first click of the for loop 602, the score will be 115; another click and the score will be 130; another click then 145, etc.

In the variables section 418, the UI 400 shows the values of the variables, which are start, score, and index, in this example. Thus, the user can check the value of the index of the for loop in the variables section 418. Each time the user clicks on the for loop 602, the value of the index variable is incremented by 1.

The ABS debugger has the option 414 to go backward (button labeled “Step Backwards”). When the go-backward option is selected, selecting the options of step over, step into, or step out will move the user backward in time. Also, if the user clicks on the for-loop instruction, then the state will move back one iteration, which means that the index variable will be decreased by one unless the for-loop has not started execution yet.

FIG. 7 illustrates debugging inside a function according to some examples. In this case, the user has selected the step-into option in the function stack 210, and the debugger has entered the function math_test 702. On the left side of the UI 400, the function stack 210 shows the instructions of math_test: create variable x1, and increment x1 by 5.

The ABS interface displays a breadcrumb trail, indicating a change in context from the previous query to the current math_test. The program executes one operation at a time, starting with the assignment of the value 230 to x1, which is the result of adding 220 (the score) and 10 in the first instruction of math_test. Upon reaching the bottom line, the value of x1 is updated to 235 as a result of adding 5. Upon further execution, the program will return to the previous parent context. This process will continue until the desired result is achieved. To expedite the process, the user may click the Continue 410 button, which will result in the final value of 250, which is the final state of execution of seantest.

Changing context can be frustrating when using traditional debuggers, for example, where flow moves from a function written by one user into a function written by another. Some benefits of the ABS include a lack of obfuscation and a consistency of coding standards. Thus, when a human programmer examines the code of another human programmer, said consistency and lack of obfuscation substantially eliminate the cognitive load of analyzing what and how a block of logic achieves its objective.

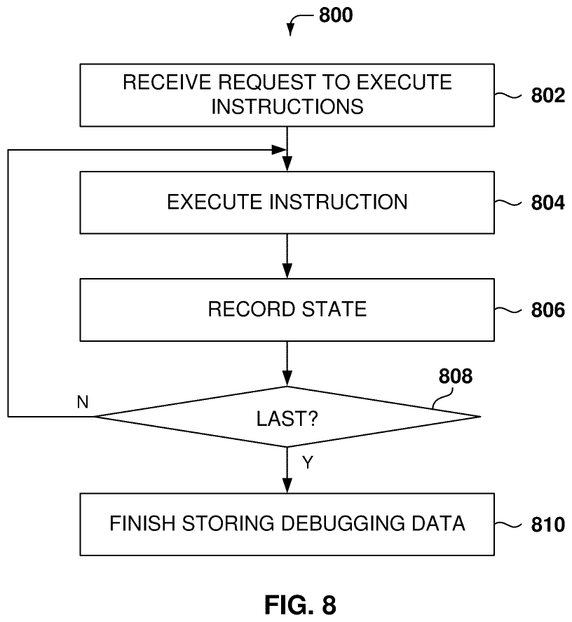

FIG. 8 is a flowchart of a method 800 for executing instructions with the active debugger, according to some examples. While the various operations in this flowchart are presented and described sequentially, one of ordinary skill will appreciate that some or all of the operations may be executed in a different order, be combined or omitted, or be executed in parallel.

Operation 802 is for receiving a request to execute instructions, such as the instructions in a function stack in the ABS.

From operation 802, the method 800 flows to operation 804 for executing one instruction. From operation 804, the method 800 flows to operation 806 for recording the state after executing the instruction. That is, the state is recorded after each instruction is executed.

In general, if the complete state of the function stack is saved after each instruction, this can result in a high demand for memory storage to accommodate the large amount of data generated. However, because with ABS, each statement typically only affects one variable, the state data is similar to the previous one. To enhance efficiency, the state snapshots are stored with variable references that point to a variable storage mechanism where each unique variable value is stored only once. Consequently, different variables can share the same reference ID if they have identical values. This means that one state only requires additional storage of one or a few variable updates, resulting in much fewer requirements for data storage. In other words, at each state, only the data that has changed from the previous stage is stored in the data package for the debugging run, together with a timestamp of when the instruction was executed. This optimization enables the debugging of complex instructions that otherwise could not be debugged if the complete state is stored after each instruction.

From operation 806, the method 800 flows to operation 808 to check if the executed instruction is the last instruction in the function start. If the executed instruction is not the last instruction, the method flows back to operation 804, and if the last instruction has been executed, the method flows to operation 810.

At operation 810, the ABS completes storing the debugging data in a data package that includes the data for all the states and the function stack. For example, the data may be stored in a database. The location of said database is not restricted and can be located on a network addressable location, in RAM, or on a local storage device such as SDRAM. Additionally, with ABS, the more compact the data package is, the easier it will be to store and transfer, which means that a small device, such as an Internet-of-Things device, can be instructed to execute logic, retain the debug state, and then ship that debug data over a network for off-line analysis.

The data package includes all the data necessary to debug the execution of the instructions. This means that the data package may be shared among users or with third parties (e.g., support providers), and other users may debug the execution of the instructions without having to execute the instructions again and without requiring access to the instructions. That is, a support agent may analyze the data from the data package without having access to the executed function stack.

One scenario where the ABS debugger is exceptionally useful is the case for highly concurrent (e.g., parallel) processing of the function stack. For example, a function stack that is run in parallel with one thousand instances executing.

The ABS debugger will record all the instances of the execution, and the user will be able to analyze all the executed instances using the ABS debugger. That is, there would be an instance of execution for each thread. Traditional debuggers are not designed for this type of execution, and highly concurrent programs would be very difficult to troubleshoot using traditional debuggers.

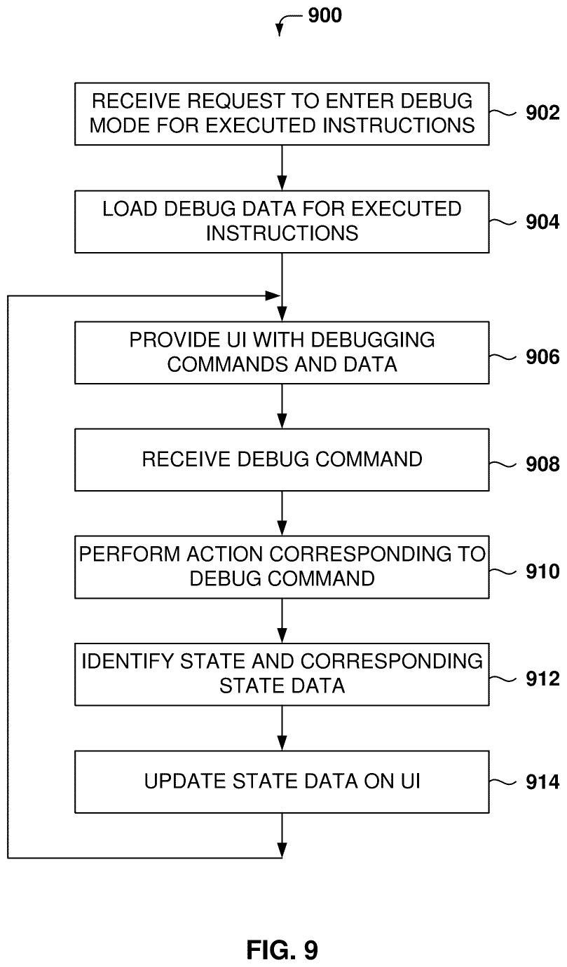

FIG. 9 is a flowchart of a method 900 for debugging previously executed instructions, according to some examples. While the various operations in this flowchart are presented and described sequentially, one of ordinary skill will appreciate that some or all of the operations may be executed in a different order, be combined or omitted, or be executed in parallel.

At operation 902, a request is received to enter debug for previously executed instructions, e.g., an ABS function stack. From operation 902, the method 900 flows to operation 904 for loading the debug data for executed instructions. It is noted that any authorized user may load the debug data, and the debugging user does not need access or authority to execute the function stack. For example, a support person may receive the debug data from a user and assist the user with troubleshooting. Because the debug data includes the values for the parameters associated with all the states of execution, any debugger can follow along to revisit the execution of the instructions.

From operation 904, the method 900 flows to operation 906 for providing a UI with debugging commands, such as the UIs presented in FIGS. 2 to 7.

From operation 906, the method 900 flows to operation 908 to receive a debug command from the user, such as the commands described above with reference to FIG. 4.

From operation 908, the method 900 flows to operation 910 to perform the action corresponding to the debug command, such as step over, step into, step out, click on an instruction of the function stack, click on a for loop, etc. The snapshot approach enables instantaneous navigation to any statement, thereby rendering the exploration of the state non-time-sensitive. Consequently, the user can freely jump forward and backward as desired. This feature confers a substantial advantage over conventional debuggers, as it allows for immediate backward navigation in real-time to gather additional information on how to debug any anomalies detected in the current state effectively.

From operation 910, the method 900 flows to operation 912 to identify the state of execution and the corresponding data.

From operation 912, the method 900 flows to operation 914 to update the UI with the data identified at operation 912.

From operation 914, the method 900 flows back to operation 906 to continue debugging unless the user selects the option to exit the debug mode or end the session with ABS.

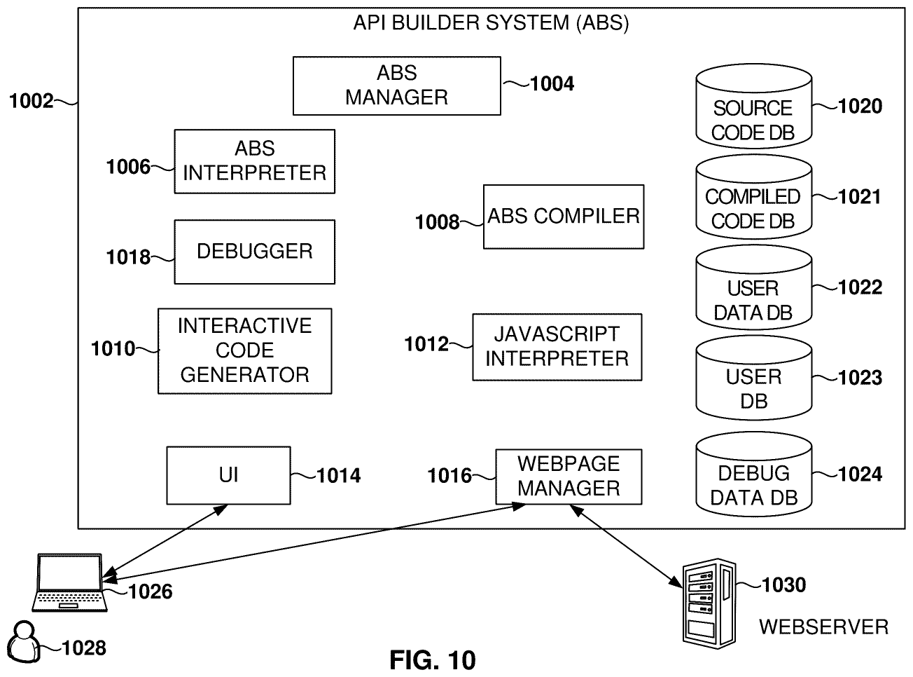

FIG. 10 is a simplified schematic diagram of a computer system for implementing the examples described herein. The ABS 1002 includes an ABS manager 1004, an ABS interpreter 1006, an ABS compiler 1008, a code generator 1010, a JavaScript interpreter 1012, a user interface (UI) 1014, a webpage manager 1016, a debugger 1018, and several data repositories including a source code database 1020, a compiled code database 1021, a user data database 1022, a user database 1023, and a debug data database 1024.

The ABS manager 1004 coordinates the operations of the ABS 1002, including interactions with the users and the different components.

The ABS interpreter 1006 is an interpreter for the ABS code, and the ABS compiler 1008 is a compiler for the ABS code. Thus, the ABS syntax may be used for compilation or interpretation.

The interactive code generator 1010 is a tool that interfaces with a user device 1026 (associated with user 1028) via the UI 1014 for the generation of ABS code, such as in the example described above with reference to FIG. 1A.

The debugger 1018 provides debugging capabilities as described herein. The JavaScript interpreter 1012 may interact with the different modules of the ABS 1002. In some examples, a user may utilize segments of code with ABS syntax and other segments in JavaScript, and the combination may be processed by the ABS 1002. The webpage manager 1016 manages the interaction via web browser with user devices 1026 and a webserver 1030.

The source code database 1020 stores source code created by users, such as ABS code. The compiled code database 1021 stores compiled code. The user data database 1022 stores data of users, and the user database 1023 keeps information about the users of the system. The debug data database 1024 stores debug data packages resulting from executing instructions in debug mode.

The ABS 1002 may also include other components, such as text editors, an Integrated Development Environment (IDE) that includes a text editor, debugger, compiler, and other tools to help programmers develop software more efficiently, libraries, operating systems, etc.

It is noted that the examples illustrated in FIG. 10 are examples and do not describe every possible example. Other examples may utilize different modules, combine modules, break modules into several submodules, perform the operations on a distributed system across multiple machines, etc. The examples illustrated in FIG. 10 should, therefore, not be interpreted to be exclusive or limiting but rather illustrative.

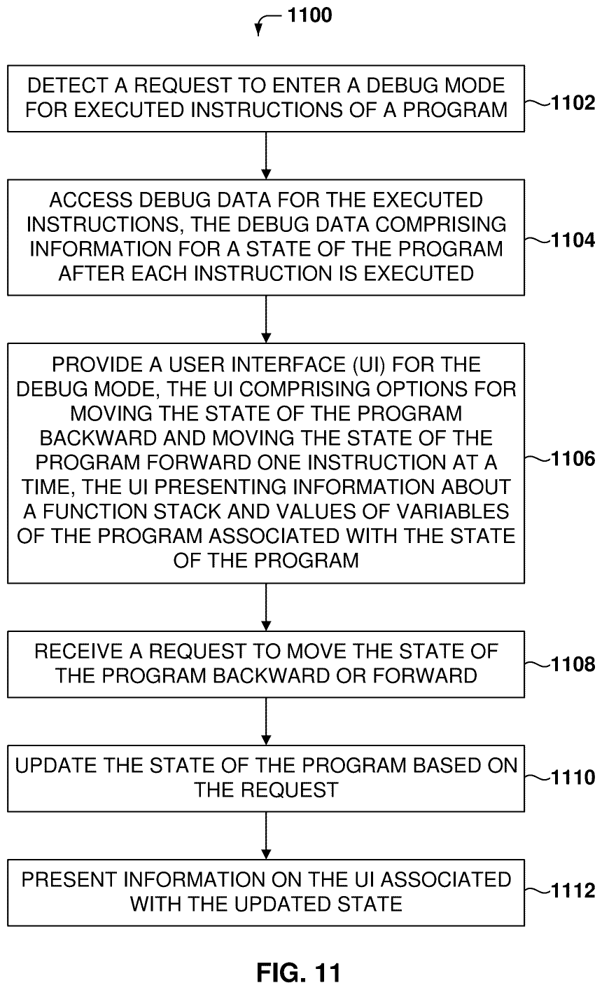

FIG. 11 is a flowchart of a method 1100 for debugging a computer program, according to some examples. While the various operations in this flowchart are presented and described sequentially, one of ordinary skill will appreciate that some or all of the operations may be executed in a different order, be combined or omitted, or be executed in parallel.

Operation 1102 includes detecting a request to enter a debug mode for executed instructions of a program. This operation initiates the debugging process by recognizing a user's intent to analyze the program's execution.

From operation 1102, the method 1100 flows to operation 1104, where the process accesses debug data for the executed instructions. The debug data comprises information on the state of the program after each instruction is executed.

Following operation 1104, the method 1100 proceeds to operation 1106, where a user interface (UI) is provided for the debug mode. The UI includes options for moving the state of the program backward and forward one instruction at a time. The interface presents information about a function stack and values of variables associated with the state of the program, enabling users to gain insights into the program's execution flow and variable states.

From operation 1106, the method 1100 advances to operation 1108, where a request is received to move the state of the program backward or forward. This operation enables users to navigate through the program's execution states, facilitating a detailed examination of the program's behavior.

The method 1100 then flows to operation 1110, which updates the state of the program based on the request received in operation 1108.

From operation 1110, the method proceeds to operation 1112. In this operation, information associated with the updated state is presented on the UI. This presentation allows users to view the current state of the program, including the function stack and variable values, thereby supporting effective debugging and analysis.

Another general aspect is for a system that includes a memory comprising instructions and one or more computer processors. The instructions, when executed by the one or more computer processors, cause the one or more computer processors to perform operations comprising: detecting a request to enter a debug mode for executed instructions of a program; accessing debug data for the executed instructions, the debug data comprising information for a state of the program after each instruction is executed; providing a user interface (UI) for the debug mode, the UI comprising options for moving the state of the program backward and moving the state of the program forward one instruction at a time, the UI presenting information about a function stack and values of variables of the program associated with the state of the program; receiving a request to move the state of the program backward or forward; updating the state of the program based on the request; and presenting information on the UI associated with the updated state.

In yet another general aspect, a tangible machine-readable storage medium (e.g., a non-transitory storage medium) includes instructions that, when executed by a machine, cause the machine to perform operations comprising: detecting a request to enter a debug mode for executed instructions of a program; accessing debug data for the executed instructions, the debug data comprising information for a state of the program after each instruction is executed; providing a user interface (UI) for the debug mode, the UI comprising options for moving the state of the program backward and moving the state of the program forward one instruction at a time, the UI presenting information about a function stack and values of variables of the program associated with the state of the program; receiving a request to move the state of the program backward or forward; updating the state of the program based on the request; and presenting information on the UI associated with the updated state.

In view of the disclosure above, various examples are set forth below. It should be noted that one or more features of an example, taken in isolation or combination, should be considered within the disclosure of this application.

Example 1. A computer-implemented method comprising: detecting a request to enter a debug mode for executed instructions of a program; accessing debug data for the executed instructions, the debug data comprising information for a state of the program after each instruction is executed; providing a user interface (UI) for the debug mode, the UI comprising options for moving the state of the program backward and moving the state of the program forward one instruction at a time, the UI presenting information about a function stack and values of variables of the program associated with the state of the program; receiving a request to move the state of the program backward or forward; updating the state of the program based on the request; and presenting information on the UI associated with the updated state.

Example 2. The method of Example 1, further comprising: executing the program to completion without stopping execution while capturing the state of the program after executing each instruction.

Example 3. The method of any one or more of Examples 1-2, wherein each state comprises information about a current function stack and values of variables.

Example 4. The method of any one or more of Examples 1-3, wherein the options in the UI comprise step over, step into, step out, and continue execution until an end of the program or reaching a breakpoint.

Example 5. The method of any one or more of Examples 1-4, wherein the debug data comprises information for all states of execution of the program, wherein the debug data may be analyzed by user without access to the program when the program was executed.

Example 6. The method of any one or more of Examples 1-5, wherein the function stack includes a set of functions that are executed in a specific order within the program.

Example 7. The method of any one or more of Examples 1-6, wherein the debug data comprises a snapshot for each state, each snapshot being stored with variable references pointing to a variable storage mechanism where each unique variable value is stored in one snapshot until the variable value changes.

Example 8. The method of any one or more of Examples 1-7, wherein the UI provides options to select any instruction in the function stack, wherein the UI moves the state to a selected instruction when the instruction is selected.

Example 9. The method of any one or more of Examples 1-8, wherein an instruction is a single command or operation of a programming language that is executed by a computer processor.

Example 10. The method of any one or more of Examples 1-9, wherein the debug mode enables instantaneous navigation to any statement thereby rendering exploration of any state non-time-sensitive.

Example 11. A system comprising: a memory comprising instructions; and one or more computer processors, the instructions, when executed by the one or more computer processors, causing the system to perform operations comprising: detecting a request to enter a debug mode for executed instructions of a program; accessing debug data for the executed instructions, the debug data comprising information for a state of the program after each instruction is executed; providing a user interface (UI) for the debug mode, the UI comprising options for moving the state of the program backward and moving the state of the program forward one instruction at a time, the UI presenting information about a function stack and values of variables of the program associated with the state of the program; receiving a request to move the state of the program backward or forward; updating the state of the program based on the request; and presenting information on the UI associated with the updated state.

Example 12. The system of any Example 11, wherein the instructions further cause the one or more computer processors to perform operations comprising: executing the program to completion without stopping execution while capturing the state of the program after executing each instruction.

Example 13. The system of any one or more of Examples 11-12, wherein each state comprises information about a current function stack and values of variables.

Example 14. The system of any one or more of Examples 11-13, wherein the options in the UI comprise step over, step into, step out, and continue execution until an end of the program or reaching a breakpoint.

Example 15. The system of any one or more of Examples 11-14, wherein the debug data comprises information for all states of execution of the program, wherein the debug data may be analyzed by user without access to the program when the program was executed.

Example 16. A non-transitory machine-readable storage medium including instructions that, when executed by a machine, cause the machine to perform operations comprising: detecting a request to enter a debug mode for executed instructions of a program; accessing debug data for the executed instructions, the debug data comprising information for a state of the program after each instruction is executed; providing a user interface (UI) for the debug mode, the UI comprising options for moving the state of the program backward and moving the state of the program forward one instruction at a time, the UI presenting information about a function stack and values of variables of the program associated with the state of the program; receiving a request to move the state of the program backward or forward; updating the state of the program based on the request; and presenting information on the UI associated with the updated state.

Example 17. The non-transitory machine-readable storage medium of Example 16, wherein the machine further performs operations comprising: executing the program to completion without stopping execution while capturing the state of the program after executing each instruction.

Example 18. The non-transitory machine-readable storage medium of any one or more of Examples 16-17, wherein each state comprises information about a current function stack and values of variables.

Example 19. The non-transitory machine-readable storage medium of any one or more of Examples 16-18, wherein the options in the UI comprise step over, step into, step out, and continue execution until an end of the program or reaching a breakpoint.

Example 20. The non-transitory machine-readable storage medium of any one or more of Examples 16-19, wherein the debug data comprises information for all states of execution of the program, wherein the debug data may be analyzed by user without access to the program when the program was executed.

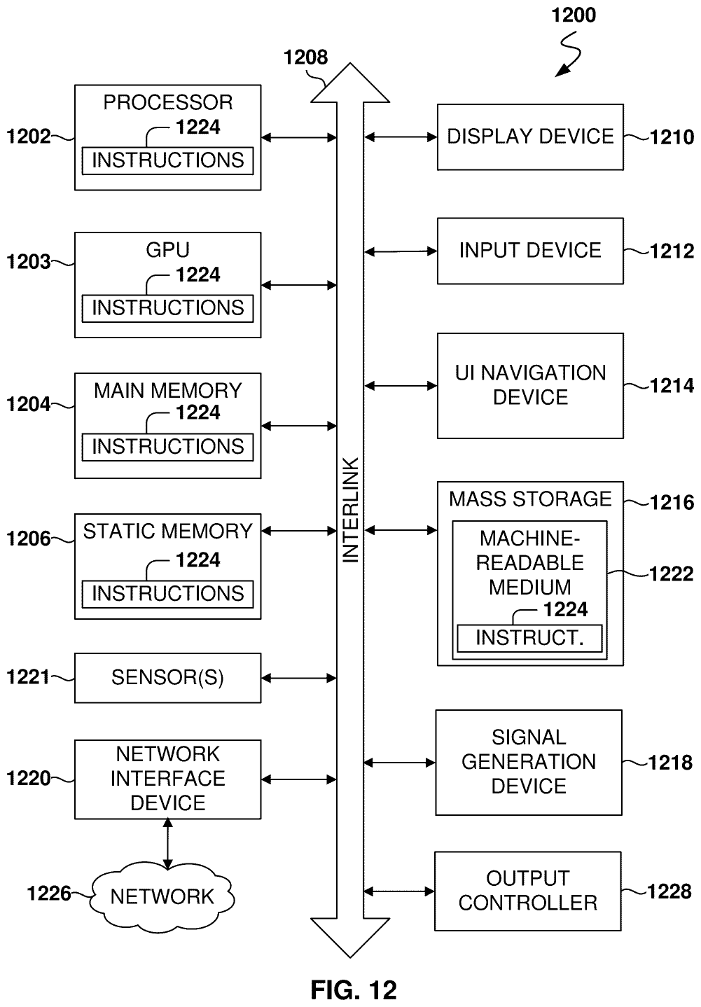

FIG. 12 is a block diagram illustrating an example of a machine 1200 upon or by which one or more example process examples described herein may be implemented or controlled. In alternative examples, the machine 1200 may operate as a standalone device or be connected (e.g., networked) to other machines. In a networked deployment, the machine 1200 may operate in the capacity of a server machine, a client machine, or both in server-client network environments. In an example, the machine 1200 may act as a peer machine in a peer-to-peer (P2P) (or other distributed) network environment. Further, while only a single machine 1200 is illustrated, the term “machine” shall also be taken to include any collection of machines that individually or jointly execute a set (or multiple sets) of instructions to perform any one or more of the methodologies discussed herein, such as via cloud computing, software as a service (SaaS), or other computer cluster configurations.

Examples, as described herein, may include, or may operate by, logic, various components, or mechanisms. Circuitry is a collection of circuits implemented in tangible entities, including hardware (e.g., simple circuits, gates, logic). Circuitry membership may be flexible over time and underlying hardware variability. Circuitries include members that may, alone or in combination, perform specified operations when operating. In an example, the hardware of the circuitry may be immutably designed to carry out a specific operation (e.g., hardwired). In an example, the hardware of the circuitry may include variably connected physical components (e.g., execution units, transistors, simple circuits), including a computer-readable medium physically modified (e.g., magnetically, electrically, by moveable placement of invariant massed particles) to encode instructions of the specific operation. In connecting the physical components, the underlying electrical properties of a hardware constituent are changed (for example, from an insulator to a conductor or vice versa). The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other circuitry components when the device operates. In an example, any of the physical components may be used in more than one member of more than one circuitry. For example, under operation, execution units may be used in a first circuit of a first circuitry at one point in time and reused by a second circuit in the first circuitry or by a third circuit in a second circuitry at a different time.

The machine 1200 (e.g., computer system) may include a hardware processor 1202 (e.g., a central processing unit (CPU), a hardware processor core, or any combination thereof), a graphics processing unit (GPU 1203), a main memory 1204, and a static memory 1206, some or all of which may communicate with each other via an interlink 1208 (e.g., bus). The machine 1200 may further include a display device 1210, an alphanumeric input device 1212 (e.g., a keyboard), and a user interface (UI) navigation device 1214 (e.g., a mouse). In an example, the display device 1210, alphanumeric input device 1212, and UI navigation device 1214 may be a touch screen display. The machine 1200 may additionally include a mass storage device 1216 (e.g., drive unit), a signal generation device 1218 (e.g., a speaker), a network interface device 1220, and one or more sensors 1221, such as a Global Positioning System (GPS) sensor, compass, accelerometer, or another sensor. The machine 1200 may include an output controller 1228, such as a serial (e.g., universal serial bus (USB)), parallel, or other wired or wireless (e.g., infrared (IR), near field communication (NFC)) connection to communicate with or control one or more peripheral devices (e.g., a printer, card reader).

The processor 1202 refers to any one or more circuits or virtual circuits (e.g., a physical circuit emulated by logic executing on an actual processor) that manipulates data values according to control signals (e.g., commands, opcodes, machine code, control words, macroinstructions, etc.) and which produces corresponding output signals that are applied to operate a machine. A processor 1202 may, for example, include at least one of a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), a Tensor Processing Unit (TPU), a Neural Processing Unit (NPU), a Vision Processing Unit (VPU), a Machine Learning Accelerator, an Artificial Intelligence Accelerator, an Application Specific Integrated Circuit (ASIC), a Field Programmable Gate Array (FPGA), a Radio-Frequency Integrated Circuit (RFIC), a Neuromorphic Processor, a Quantum Processor, or any combination thereof.

The processor 1202 may further be a multi-core processor having two or more independent processors (sometimes referred to as “cores”) that may execute instructions contemporaneously. Multi-core processors contain multiple computational cores on a single integrated circuit die, each of which can independently execute program instructions in parallel. Parallel processing on multi-core processors may be implemented via architectures like superscalar, VLIW, vector processing, or SIMD that allow each core to run separate instruction streams concurrently. The processor 1202 may be emulated in software, running on a physical processor, as a virtual processor or virtual circuit. The virtual processor may behave like an independent processor but is implemented in software rather than hardware.

The mass storage device 1216 may include a machine-readable medium 1222 on which one or more sets of data structures or instructions 1224 (e.g., software) embodying or utilized by any of the techniques or functions described herein. The instructions 1224 may also reside, completely or at least partially, within the main memory 1204, within the static memory 1206, within the hardware processor 1202, or the GPU 1203 during execution thereof by the machine 1200. For example, one or any combination of the hardware processor 1202, the GPU 1203, the main memory 1204, the static memory 1206, or the mass storage device 1216 may constitute machine-readable media.

While the machine-readable medium 1222 is illustrated as a single medium, the term “machine-readable medium” may include a single medium or multiple media (e.g., a centralized or distributed database and associated caches and servers) configured to store one or more instructions 1224.

The term “machine-readable medium” may include any medium that is capable of storing, encoding, or carrying instructions 1224 for execution by the machine 1200 and that causes the machine 1200 to perform any one or more of the techniques of the present disclosure or that is capable of storing, encoding, or carrying data structures used by or associated with such instructions 1224. Non-limiting machine-readable medium examples may include solid-state memories and optical and magnetic media. For example, a massed machine-readable medium comprises a machine-readable medium 1222 with a plurality of particles having invariant (e.g., rest) mass. Accordingly, massed machine-readable media are not transitory propagating signals. Specific examples of massed machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1224 may be transmitted or received over a communications network 1226 using a transmission medium via the network interface device 1220.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented separately. These and other variations, modifications, additions, and improvements fall within the scope of the subject matter herein.

The examples illustrated herein are described in sufficient detail to enable those skilled in the art to practice the teachings disclosed. Other examples may be used and derived therefrom, such that structural and logical substitutions and changes may be made without departing from the scope of this disclosure. The Detailed Description, therefore, is not to be taken in a limiting sense, and the scope of various examples is defined only by the appended claims, along with the full range of equivalents to which such claims are entitled.

Additionally, as used in this disclosure, phrases of the form “at least one of an A, a B, or a C,” “at least one of A, B, and C,” and the like should be interpreted to select at least one from the group that comprises “A, B, and C.” Unless explicitly stated otherwise in connection with a particular instance, in this disclosure, this manner of phrasing does not mean “at least one of A, at least one of B, and at least one of C.” As used in this disclosure, the example “at least one of an A, a B, or a C” would cover any of the following selections: {A}, {B}, {C}, {A, B}, {A, C}, {B, C}, and {A, B, C}.

Moreover, plural instances may be provided for resources, operations, or structures described herein as a single instance. Additionally, boundaries between various resources, operations, modules, engines, and data stores are somewhat arbitrary, and particular operations are illustrated in the context of specific illustrative configurations. Other allocations of functionality are envisioned and may fall within the scope of various examples of the present disclosure. In general, structures and functionality are presented as separate resources in the example; configurations may be implemented as a combined structure or resource. Similarly, structures and functionality presented as a single resource may be implemented as separate resources. These and other variations, modifications, additions, and improvements fall within a scope of examples of the present disclosure as represented by the appended claims. Accordingly, the specification and drawings are to be regarded in an illustrative rather than a restrictive sense.

What is claimed is:

1. A computer-implemented method comprising:
detecting a request to enter a debug mode for executed instructions of a program;
accessing debug data for the executed instructions, the debug data comprising information for a state of the program after each instruction is executed;
providing a user interface (UI) for the debug mode, the UI comprising options for moving the state of the program backward and moving the state of the program forward one instruction at a time, the UI presenting information about a function stack and values of variables of the program associated with the state of the program;
receiving a request to move the state of the program backward or forward;
updating the state of the program based on the request; and
presenting information on the UI associated with the updated state.

2. The method as recited in claim 1, further comprising:
executing the program to completion without stopping execution while capturing the state of the program after executing each instruction.

3. The method as recited in claim 1, wherein each state comprises information about a current function stack and values of variables.

4. The method as recited in claim 1, wherein the options in the UI comprise step over, step into, step out, and continue execution until an end of the program or reaching a breakpoint.

5. The method as recited in claim 1, wherein the debug data comprises information for all states of execution of the program, wherein the debug data may be analyzed by user without access to the program when the program was executed.

6. The method as recited in claim 1, wherein the function stack includes a set of functions that are executed in a specific order within the program.

7. The method as recited in claim 1, wherein the debug data comprises a snapshot for each state, each snapshot being stored with variable references pointing to a variable storage mechanism where each unique variable value is stored in one snapshot until the variable value changes.

8. The method as recited in claim 1, wherein the UI provides options to select any instruction in the function stack, wherein the UI moves the state to a selected instruction when the instruction is selected.

9. The method as recited in claim 1, wherein an instruction is a single command or operation of a programming language that is executed by a computer processor.

10. The method as recited in claim 1, wherein the debug mode enables instantaneous navigation to any statement, thereby rendering exploration of any state non-time-sensitive.

11. A system comprising:
a memory comprising instructions; and
one or more computer processors, the instructions, when executed by the one or more computer processors, causing the system to perform operations comprising:
detecting a request to enter a debug mode for executed instructions of a program;
accessing debug data for the executed instructions, the debug data comprising information for a state of the program after each instruction is executed;
providing a user interface (UI) for the debug mode, the UI comprising options for moving the state of the program backward and moving the state of the program forward one instruction at a time, the UI presenting information about a function stack and values of variables of the program associated with the state of the program;
receiving a request to move the state of the program backward or forward;
updating the state of the program based on the request; and
presenting information on the UI associated with the updated state.

12. The system as recited in claim 11, wherein the instructions further cause the one or more computer processors to perform operations comprising:
executing the program to completion without stopping execution while capturing the state of the program after executing each instruction.

13. The system as recited in claim 11, wherein each state comprises information about a current function stack and values of variables.

14. The system as recited in claim 11, wherein the options in the UI comprise step over, step into, step out, and continue execution until an end of the program or reaching a breakpoint.

15. The system as recited in claim 11, wherein the debug data comprises information for all states of execution of the program, wherein the debug data may be analyzed by user without access to the program when the program was executed.

16. A non-transitory machine-readable storage medium including instructions that, when executed by a machine, cause the machine to perform operations comprising:
detecting a request to enter a debug mode for executed instructions of a program;
accessing debug data for the executed instructions, the debug data comprising information for a state of the program after each instruction is executed;
providing a user interface (UI) for the debug mode, the UI comprising options for moving the state of the program backward and moving the state of the program forward one instruction at a time, the UI presenting information about a function stack and values of variables of the program associated with the state of the program;
receiving a request to move the state of the program backward or forward;
updating the state of the program based on the request; and
presenting information on the UI associated with the updated state.

17. The non-transitory machine-readable storage medium as recited in claim 16, wherein the machine further performs operations comprising:
executing the program to completion without stopping execution while capturing the state of the program after executing each instruction.

18. The non-transitory machine-readable storage medium as recited in claim 16, wherein each state comprises information about a current function stack and values of variables.

19. The non-transitory machine-readable storage medium as recited in claim 16, wherein the options in the UI comprise step over, step into, step out, and continue execution until an end of the program or reaching a breakpoint.

20. The non-transitory machine-readable storage medium as recited in claim 16, wherein the debug data comprises information for all states of execution of the program, wherein the debug data may be analyzed by user without access to the program when the program was executed.
